(19) United States
(12) Patent Application Publication
(10) Pub. No.: US 2012/0011459 A1
(43) Pub. Date: Jan. 12, 2012

(54) APPARATUS AND METHOD FOR PRESENTING INFORMATION OF AN INDUSTRIAL PLANT

(75) Inventors: John Arvee Ocampo, Singapore (SG); Gait Chun Khoo, Singapore (SG)

(73) Assignee: YOKOGAWA ELECTRIC CORPORATION, Tokyo (JP)

(21) Appl. No.: 12/833,315

(22) Filed: Jul. 9, 2010

(51) Int. Cl. G06F 3/048

(52) U.S. Cl. 715/771

(57) ABSTRACT

An apparatus and method for presenting information of an industrial plant in a distributed control system. The apparatus comprises at least one layout manager configured for displaying and managing at least one layout of view displays; and a plurality of view processes, each view display being controlled by one of the plurality of view processes. The method comprises automatically displaying at least one layout of view displays, each view display being controlled by one of a plurality of view processes.

### FIELD OF THE INVENTION

The invention relates to an apparatus and method for presenting information of an industrial plant and particularly, though not exclusively, relates to presenting information of the plant in a distributed control system.

### BACKGROUND

Distributed Control Systems (DCS) are typically used to monitor and control manufacturing processes in industrial plants. In the DCS, a user is typically presented with information of the industrial plant via a display of graphical windows. Each window may comprise multiple view displays, and is typically a single computing process. Multiple view displays may therefore be associated with one process in a single window. With each view display being an in-process module, any problems with one view display affects the process, thereby also affecting the other view displays.

In order to achieve higher performance, increasing the number of threads per process can help to distribute workload, although this is still subject to reliability issues when one in-process module experiences problems, thereby affecting the entire process. Alternatively, higher performance may be achieved by providing only one view display per process so that long-running and job intensive tasks may be carried out without stopping the processing of other windows.

However, to monitor multiple aspects of a plant in one screen, multiple individual processes need to be launched and displayed in order to show multiple view displays at once. This clutters the screen with multiple windows such that DCS users are required to manually resize and rearrange each individual window on the screen in order to maximize visibility of the information presented.

### SUMMARY OF THE INVENTION

According to a first exemplary aspect, there is provided an apparatus for presenting information of an industrial plant in a distributed control system, the apparatus comprising at least one layout manager configured for displaying and managing at least one layout of view displays; and a plurality of view processes, each view display being controlled by one of the plurality of view processes.

The at least one layout may be automatically displayed according to a predetermined implementation of the at least one layout manager.

The apparatus may further comprise a second layout manager configured for displaying and managing a second layout of view displays.

The apparatus may further comprise a function manager configured for executing domain-specific commands including sending commands to the layout manager and to the view processes controlling the view displays.

The function manager may be further configured for transferring a view display from one layout manager to another layout manager so as to provide a change in displaying the layouts.

The function manager may further be configured for assigning one layout manager to another layout manager so as to provide a complex display of the layouts.

Each view process may be configured to execute commands from the layout manager and the function manager for controlling its view display.

According to a second exemplary aspect, there is provided a method of presenting information of an industrial plant in a distributed control system, the method comprising automatically displaying at least one layout of view displays, each view display being controlled by one of a plurality of view processes.

Each layout may be automatically displayed by a layout manager according to a predetermined implementation of the layout manager.

The method may further comprise transferring a view display from one layout manager to another layout manager so as to provide a change in display of layouts.

The transferring may be performed by a function manager.

The method may further comprise assigning one layout manager to another layout manager so as to provide a nested display of layouts.

The assigning may be performed by a function manager.

The method may further comprise each view process executing commands from the function manager to control its view display.

The method may further comprise each view process executing commands from the layout manager to control its view display.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is a schematic illustration of exemplary layouts of view displays;

FIG. 2 is an exemplary architecture diagram of an exemplary apparatus for displaying plant information in a DCS;

FIG. 3 is an exemplary layout of view displays in a tabbed format;

FIG. 4 is an exemplary layout of view displays in a docked format;

FIG. 5 is an exemplary layout of view displays in multiple-window format; and

FIG. 6 is a flowchart of an exemplary use of the apparatus of FIG. 2.

### DETAILED DESCRIPTION OF THE EXEMPLARY EMBODIMENTS

An exemplary method 100 and apparatus 10 for presenting information of an industrial plant in a DCS will be described with reference to FIGS. 1 to 6 below.

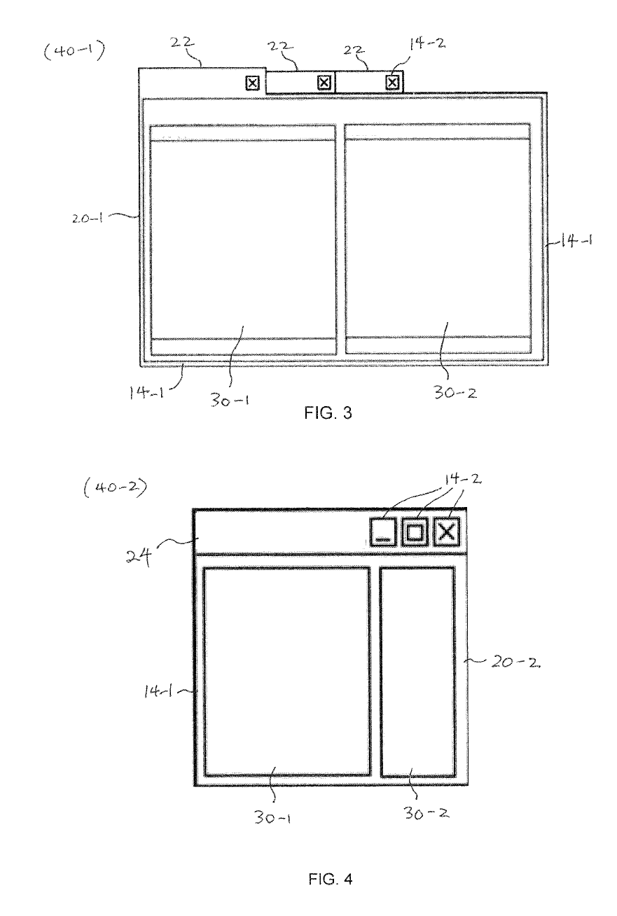

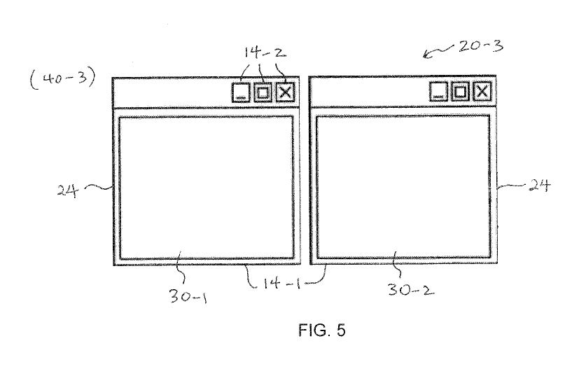

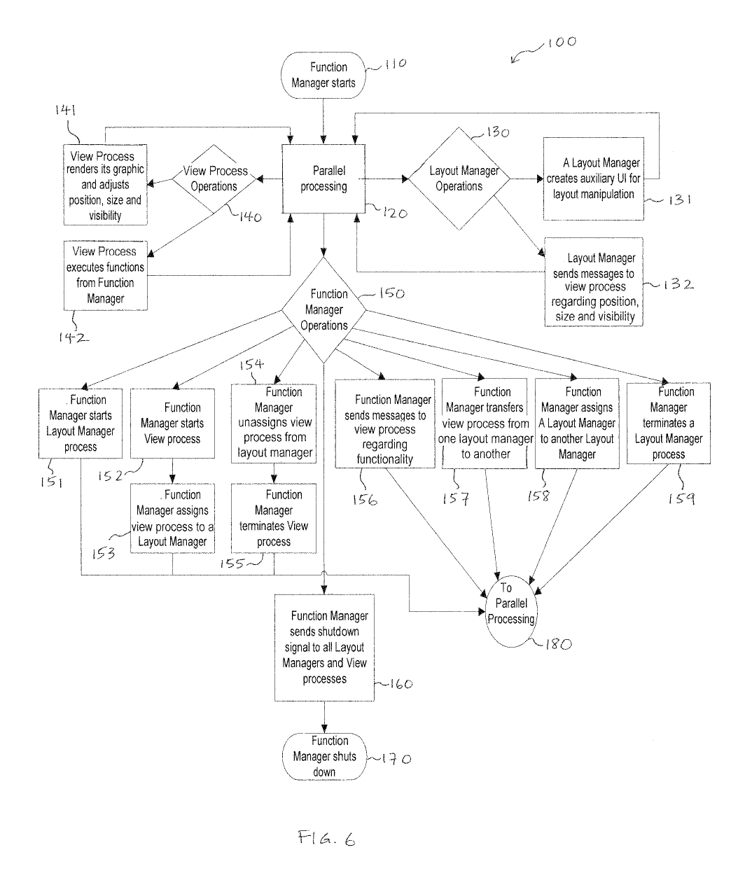

As shown in FIG. 1, in an exemplary embodiment, information of the industrial plant may be displayed in predetermined layouts 20, with each layout 20 comprising a number of view displays 30. The layouts 20 can take on different formats. For example, a grid format may be used as shown in layout 20-0 in FIG. 1. A layout 20-1 may also be displayed in tabbed format as shown in FIG. 3, where each tab 22 comprises one or more view displays 30-1, 30-2. Alternatively, a layout 20-2 may be displayed in a docked format as shown in FIG. 4, where a number of view displays 30-1, 30-2 are shown in a single window 24. A layout 20-3 may alternatively comprise a number of individual windows 24 each comprising one or more view displays 30-1, 30-2, as shown in FIG. 5.

Each view display 30 typically provides a specific and unique type of information about the industrial plant to a DCS user. For example, one view display 30-1 may show the temperature of a chemical reactor in the industrial plant, while another view display 30-2 may show a particular chemical concentration in the same chemical reactor. By automatically showing both view displays 30-1, 30-2 in a same layout 20-1 as shown in FIG. 3, the layout 20-1 can thus be configured to automatically display related information about the chemical reactor. Each layout 20 therefore can be used to group related view displays 30 together so that information about the industrial plant can be provided to the DCS user in an automatically organized and quickly understood way, maximizing screen capacity.

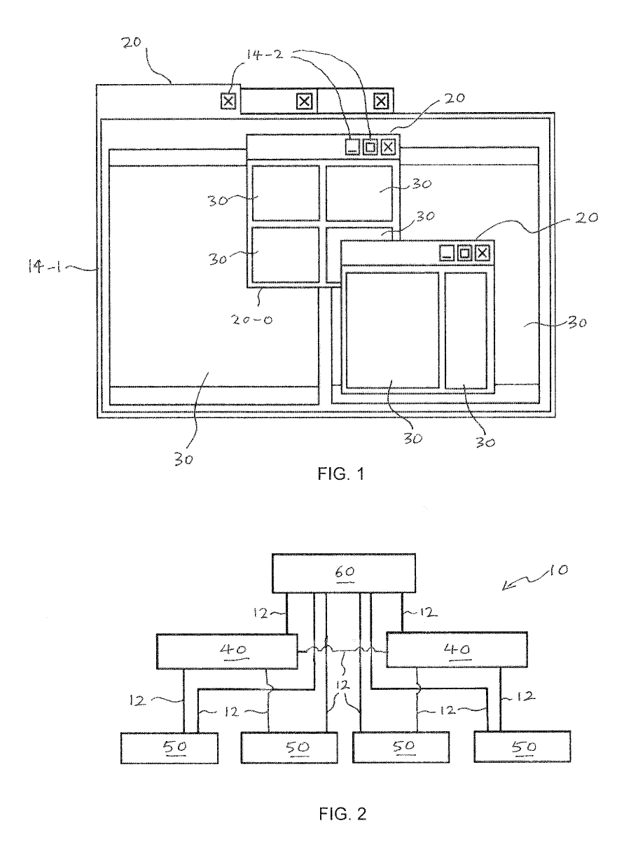

Each view display 30 is controlled by a view process 50. The apparatus 10 as shown in FIG. 2 comprises a plurality of view processes 50 that are each assignable to a layout manager 40 to run a view display 30 in a layout 20. Each view process 50 is a computing process that can be run in parallel with other view processes 50 as well as in parallel with layout managers 40. A view process 50 typically hosts graphics that are to be shown to a DCS user in the view display 30, as well as contains libraries needed to manipulate and render the graphics and to retrieve relevant data from other software modules in the DCS. Because the view processes 50 are independent of one another, if view one process 50 closes, other view processes 50 will not be affected.

Each layout 20 is managed by a layout manager 40 of the apparatus 10 as shown in FIG. 2. Every layout manager 40 comprises a computing process that can be run in parallel with other layout managers 40, and is configured for displaying and managing a layout 20 of view displays 30. For example, a layout manager 40-1 may be implemented to arrange view displays 30 always in a tabbed layout 20-1. Another layout manager 40-2 may be implemented to arrange view displays 30 always in a docked layout 20-2. A further layout manager 40-3 may be implemented to arrange view displays 30 always in a layout 20-3 of individual windows 24. A grid format 20-0 may also be implemented. This is achieved by the layout manager 40 sending commands to view processes 50 that have been assigned to it for directing the positioning, sizing and visibility of each of the view displays 30 whenever a layout 20 is started or updated (132), as shown in FIG. 6. Accordingly, each view process 50 renders the contents of its view display 30 in adherence to the position, sizing and visibility commands sent from the layout manager 40 (141) that it has been assigned to. Each layout manager 40 may also create an auxiliary user-interface for layout manipulation (131) by creating user-interface objects or visual components such as grid splitters, resizing bars 14-1, hide and other buttons 14-2 so that a user may adjust the display of each layout 20.

With each layout manager 40 configured as an individual computing process, multiple layouts 20 may be displayed and managed concurrently. FIG. 1 shows how multiple layouts 20 controlled by corresponding multiple layout managers 40 can be simultaneously displayed. The layout managers 40 are preferably configured such that one layout manager 40 may control another layout manager 40 in order to achieve complex or nested layout scenarios, an example of which is shown in FIG. 1. In addition, the layout managers 40 may further be configured to allow view processes 50 to be transferred between different layout managers 40-1, 40-2, 40-3. In this way, information provided via the same view processes 50 may be displayed in dynamically changed layouts 20 from tabbed 20-1 to docked 20-2 to individual windows 20-3, as may be desired, providing graphical user-interface flexibility.

The apparatus 10 also comprises a function manager 60 wherein use of the apparatus 10 begins with the function manager 60 starting (110) and going on to initiate parallel processing (120) of operations of the view processes 60 (140) and operations of the layout managers 40 (130). The function manager 60 is configured for executing domain-specific commands and to send commands to the layout managers 40 and view processes 50, such as messages regarding functionality (156). The function manager 60 is configured to start (151), terminate (159) and shut down (160) each layout manager 40, as well as to start (152), terminate (155) and shut down (160) each view process 50. The function manager is also configured to assign (153) and unassign (154) view processes 50 to layout managers 40. The function manager 50 is further also configured to transfer view processes 50 from one layout manager 40 to another layout manager 40 (157) in order to permit dynamic changing of layouts 20 as described above. The function manager 50 is yet further configured to assign one layout manager 40 to be controlled by another layout manager 40 (158) in order to achieve complex layout scenarios as described above.

Communication between each view process 50 and its corresponding layout manager 40 as well as between the function manager 60 and the view processes 50 and layout managers 40 is achieved through an inter-process communication protocol (IPCP) 12, as shown in FIG. 2. The IPCP 12 may be implemented in a variety of ways such as windows messages and windows communication framework (WCF), for example. Commands may be sent from the function manager 60 to view processes 50 via IPCP 12 for execution by the view processes 50 of domain-specific functions from the function manager 60 such as blinking and data updating (142).

By configuring each view display 30 to be controlled by an individual view process 50, in the event that one view display 30 hangs or crashes or experiences any other unexpected failure, other view displays 30 are not affected because each view process 50 is independent of the other view processes 50, and therefore run independently of or in parallel with the other view processes 50. This improves reliability of the layouts 20 so that only an affected view display 30 becomes unavailable while other information continues to be displayed via the other view processes 50 that are still running their corresponding view displays 30.

The apparatus 10 and method described therefore exploit the performance of multi-core systems by providing the layout managers 40, view processes 50 and function manager 60 as individual processes. In this way, graphical user-interface flexibility, reliability and performance are provided in a single architecture while overcoming the screen clutter associated with using conventional multiple window processes. In addition, complex layout scenarios can be achieved when running multiple processes, while also allowing dynamic change of the layouts 20 to be effected. The invention also provides a platform for minimizing reengineering required when developing further DCS software modules.

Whilst there has been described in the foregoing description exemplary embodiments of the present invention, it will be understood by those skilled in the technology concerned that many variations in details of design, construction and/or operation may be made without departing from the present invention.

1. An apparatus for presenting information of an industrial plant in a distributed control system, the apparatus comprising:
at least one layout manager configured for displaying and managing at least one layout of view displays; and
a plurality of view processes, each view display being controlled by one of the plurality of view processes.

2. The apparatus of claim 1, wherein the at least one layout is automatically displayed according to a predetermined implementation of the at least one layout manager.

3. The apparatus of claim 1, further comprising a second layout manager configured for displaying and managing a second layout of view displays.

4. The apparatus of claim 1, further comprising a function manager configured for executing domain-specific commands including sending commands to the layout manager and to the view processes controlling the view displays.

5. The apparatus of claim 1, further comprising another layout manager configured for displaying and managing another layout of view displays, and further comprising a function manager configured for executing domain-specific commands including sending commands to each layout manager and to the view processes controlling the view displays, wherein the function manager is further configured for transferring a view display from one layout manager to another layout manager so as to provide a change in displaying the layouts.

6. The apparatus of claim 1, further comprising another layout manager configured for displaying and managing another layout of view displays, and further comprising a function manager configured for executing domain-specific commands including sending commands to each layout manager and to the view processes controlling the view displays, wherein the function manager is further configured for assigning one layout manager to another layout manager so as to provide a complex display of the layouts.

7. The apparatus of claim 4, wherein each view process is configured to execute commands from the layout manager and the function manager for controlling its view display.

8. A method of presenting information of an industrial plant in a distributed control system, the method comprising:
automatically displaying at least one layout of view displays, each view display being controlled by one of a plurality of view processes.

9. The method of claim 8, wherein each layout is automatically displayed by a layout manager according to a predetermined implementation of the layout manager.

10. The method of claim 9, further comprising transferring a view display from one layout manager to another layout manager so as to provide a change in display of layouts.

11. The method of claim 9, wherein the transferring is performed by a function manager.

12. The method of claim 9, further comprising assigning one layout manager to another layout manager so as to provide a nested display of layouts.

13. The method of claim 9, wherein the assigning is performed by a function manager.

14. The method of claim 13, further comprising each view process executing commands from the function manager to control its view display.

15. The method of claim 9, further comprising each view process executing commands from the layout manager to control its view display.
